(19) United States
(12) Patent Application Publication
(10) Pub. No.: US 2015/0026994 A1
(43) Pub. Date: Jan. 29, 2015

(54) APPARATUS FOR PREVENTING AN ENTANGLEMENT OF SHEETS IN A DRYER

(71) Applicant: JACK M. HOLDER, Fresno, CA (US)

(72) Inventor: JACK M. HOLDER, Fresno, CA (US)

(21) Appl. No.: 14/338,569

(22) Filed: Jul. 23, 2014

Related U.S. Application Data
(60) Provisional application No. 61/857,387, filed on Jul. 23, 2013.

(51) Int. Cl. F26B 25/00

(52) U.S. Cl. CPC F26B 25/004
USPC 34/236

(57) ABSTRACT

An apparatus for use with a dryer to prevent an entanglement of sheets disposed therein and to reduce energy consumed and a time required to dry the sheets is provided. The apparatus includes a center hub with a plurality of tubular prongs oriented such that each tubular prong is equidistant from each adjacent tubular prong, and a plurality of tubular members with first ends affixed to the plurality of tubular prongs. Second ends of the plurality of tubular members are configured to sufficiently contact the sheets to create a separation between the sheets to enhance air flow around the sheets when the dryer is operating.

### RELATED APPLICATION

The application claims priority to provisional patent application U.S. Ser. No. 61/857,387 filed on Jul. 23, 2013, the entire contents of which is herein incorporated by reference.

### BACKGROUND

The embodiments herein relate generally to clothes dryers. More specifically, embodiments of the present invention relate to a dryer apparatus for preventing an entanglement of bed sheets while in the dryer.

Residential and commercial clothes dryers are used to tumble dry laundry placed within a compartment. Items such as bed sheets are difficult to dry because they often clump together into a ball and/or tangle with each other or with other laundry. This prevents the entire surfaces of the sheets from being exposed to the hot air flow within the dryer, which may result in sheets that remain wet after a drying cycle. This significantly wastes energy and increases the time required to dry the sheets.

U.S. Patent Application Publication 2010/0205787 discloses an apparatus for preventing bed sheets from an entanglement during a drying cycle. However, this apparatus is disadvantageous because it requires a user to secure the edges of each sheet to arms of the device prior to drying the sheets. This process requires additional user effort for each dryer cycle, which reduces efficiency when drying the sheets.

As such, there is a need in the industry for an apparatus that prevents an entanglement of sheets in a dryer, which enhances drying efficiency and minimizes user effort.

### SUMMARY

An apparatus for use with a dryer to prevent an entanglement of sheets disposed therein and configured to reduce energy consumed by the dryer and a time required to dry the sheets is provided. The apparatus comprises a center hub comprising a plurality of tubular prongs oriented such that each tubular prong is equidistant from each adjacent tubular prong, and a plurality of tubular members comprising first ends affixed to the plurality of tubular prongs, wherein second ends of the plurality of tubular members are configured to sufficiently contact the sheets to create a separation between the sheets to enhance air flow around the sheets when the dryer is operating.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the apparatus shown in use;

FIG. 2 depicts a perspective view of certain embodiments of the apparatus;

FIG. 3 depicts a section view of certain embodiments of the apparatus taken along line 3-3 in FIG. 2;

FIG. 4 depicts a section view of certain embodiments of the apparatus;

FIG. 5 depicts a section view of certain embodiments of the apparatus depicting an alternate hub;

FIG. 6 depicts a perspective view of an alternate embodiment of the apparatus;

FIG. 7 depicts an exploded view of the alternate embodiment of the apparatus;

FIG. 8 depicts a perspective view of the alternate embodiment of the apparatus depicting a spherical hub half; and

FIG. 9 depicts a section view of the alternate embodiment of the apparatus taken along line 9-9 in FIG. 6.

### DETAILED DESCRIPTION OF CERTAIN EMBODIMENTS

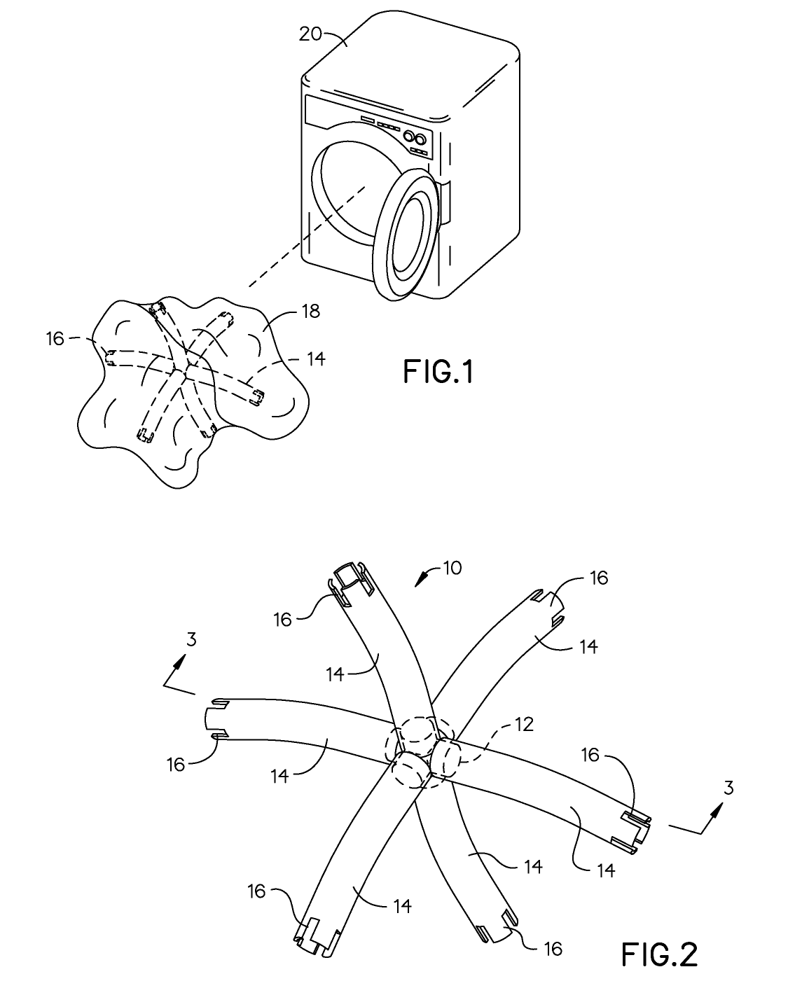

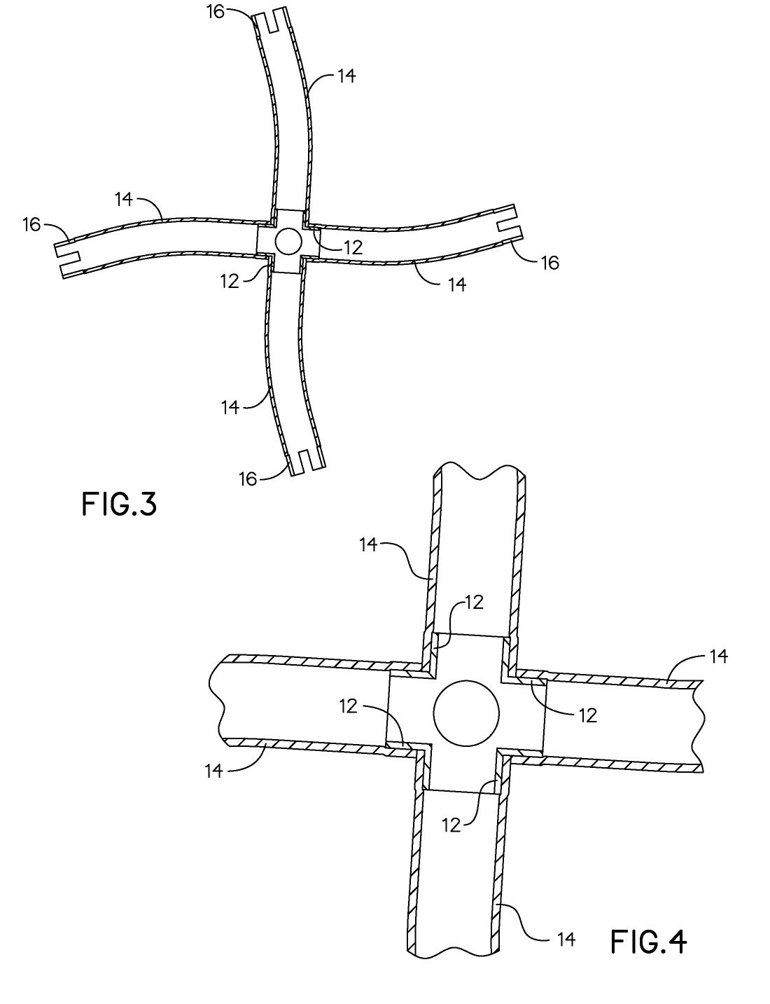

As depicted in FIGS. 1-4, dryer apparatus 10 is configured to be used with sheet 18 in dryer 20. It is understood that sheet 18 may include one or more sheets that are placed within dryer 20. Alternatively, sheet 18 may be combined with any other types of laundry that will be placed in dryer 20. Dryer 20 may be any type of residential or commercial dryer known in the field that has a tumble dry cycle.

Dryer apparatus 10 comprises hub 12 and flexible arms 14. In a preferred embodiment, hub 12 is made from polyvinyl chloride (“PVC”) plastic and comprises six tubular prongs that are oriented such that each tubular prong is equidistant from each adjacent tubular prong. Specifically, each tubular prong of hub 12 is positioned approximately 90 degrees from each adjacent tubular prong. Flexible arms 14 are tubular members that are made from PVC plastic. In a preferred embodiment, each flexible arm 14 has a 1″ outer diameter and a 3/16″ wall thickness. Each flexible arm 14 comprises a first open end that is secured over a tubular prong of hub 12 and a second open end that comprises notches 16 disposed thereon. In a preferred embodiment, four notches 16 are positioned on the second end of flexible arm 14 and equally spaced from one another. Each notch 16 has approximate dimensions of a ¼″ width and 1″ length. Once flexible arms 14 and hub 12 are assembled, dryer apparatus 10 comprises an approximate width of 11″.

In operation, wet sheets such as bed sheets are placed within dryer 20, along with dryer apparatus 10. Although one dryer apparatus 10 is required to be placed within dryer 20, it is understood that multiple dryer apparatuses 10 may be used at the same time to achieve a similar result. During a tumble dry cycle of dryer 20, the second open ends of flexible arms 14 sufficiently contact the sheets to create a separation between the sheets, which prevents the sheets from tangling or clumping into a ball. As a result, air flow is enhanced around the sheets, which significantly reduces the drying time required and energy consumed by dryer 20. Notches 16 enhance friction between the sheets and the second ends of flexible arms 14, which enables flexible arms 14 to have an improved grip on the sheets. In addition, notches 16 improve the flexibility of the second ends of flexible arms 14, which reduces the noise of dryer apparatus 10 during a tumble dry cycle. This makes dryer apparatus 10 ideal for use with residential dryers or in any location where reduced noise is desired.

In an alternative embodiment of the invention, the first ends of flexible arms 14 may be secured within the tubular prongs of hub 22 as depicted in FIG. 5. This is another design configuration that those skilled in the art may appreciate.

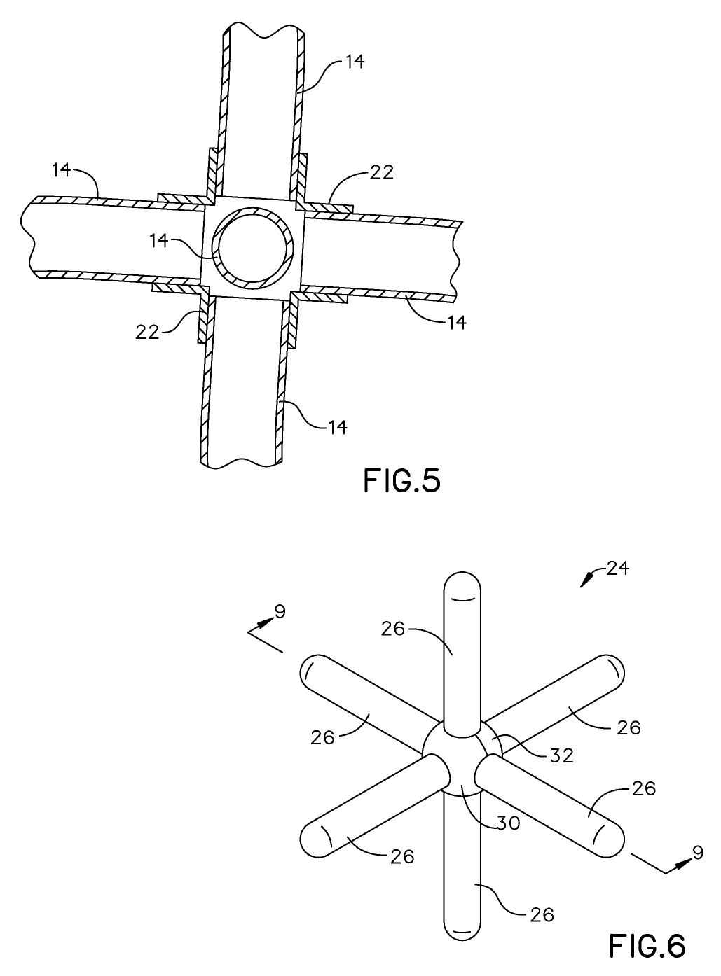

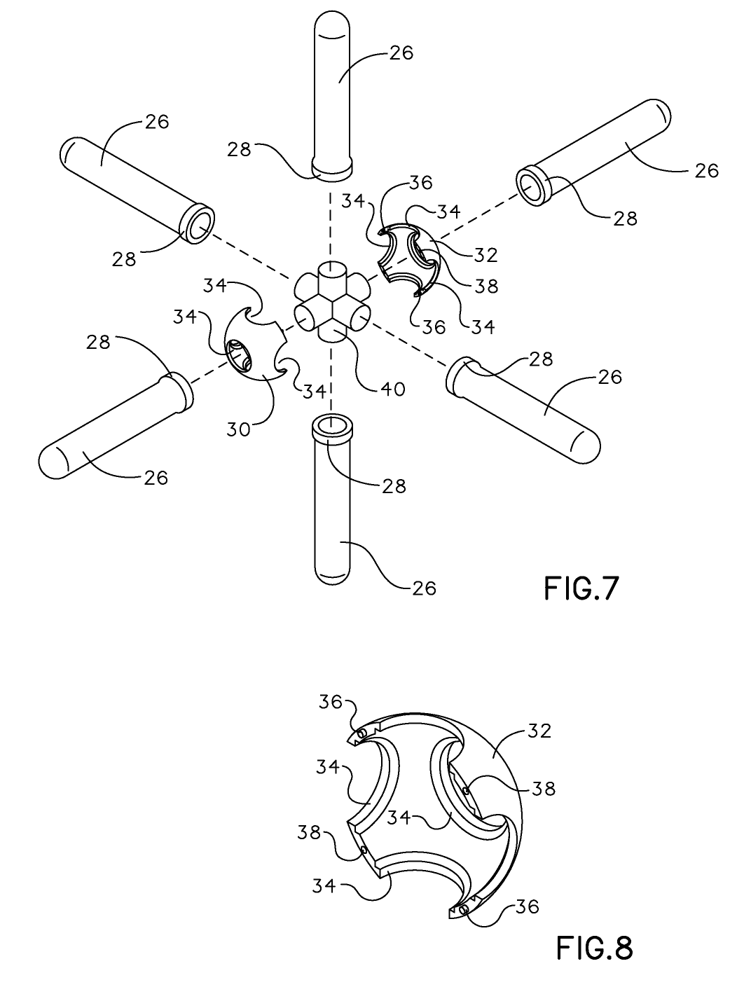

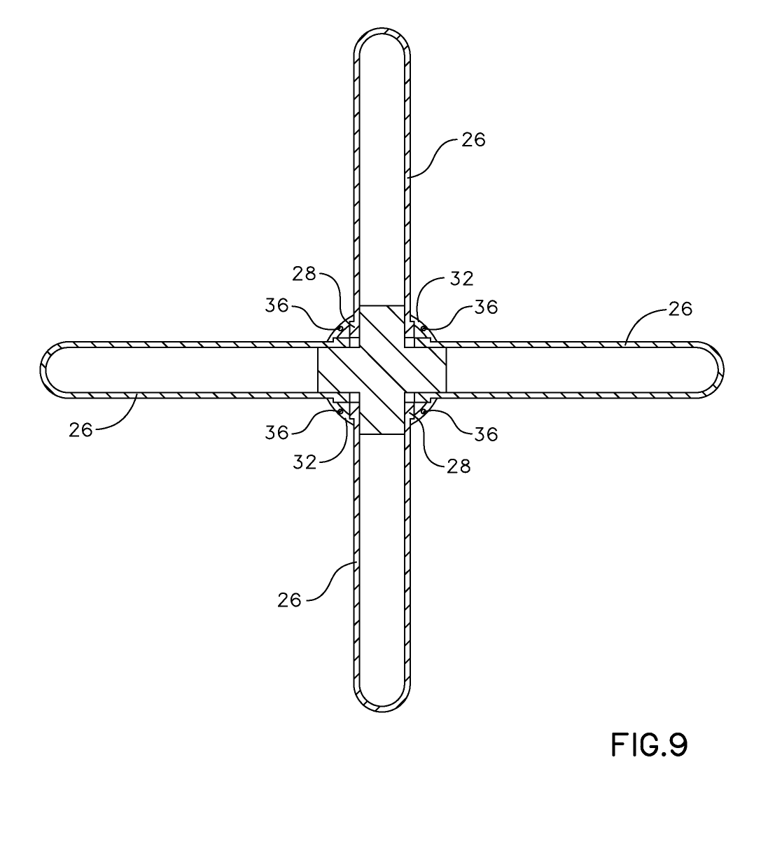

In yet another alternative embodiment of the invention, alternate dryer apparatus 24 is disclosed. As depicted in FIG. 6, alternate dryer apparatus 24 comprises first half of spherical hub 30, second half of spherical hub 32 and arms 26. As depicted in FIGS. 7-8, first half of spherical hub 30 and second half of spherical hub 32 both comprise spherical hub arm openings 34. First half of spherical hub 30 and second half of spherical hub 32 are secured together to enclose arm hub 40, which comprises a plurality of prongs. In this secured configuration, spherical hub arm openings 34 of first half of spherical hub 30 and second half of spherical hub 32 form circular openings configured to receive arms 26. First half of spherical hub 30 and second half of spherical hub 32 are secured together by any fastening components such as spherical hub tabs 36 and spherical hub slots 38. In a preferred embodiment, first half of spherical hub 30, second half of spherical hub 32 and arm hub 40 are made from urethane. Arms 26 are tubular members made from urethane and comprising a 1¾″ outer diameter and a ⅛″ wall thickness. Each arm 26 comprises arm base 28 on a first open end and a second closed end comprising a half spherical surface. As depicted in FIG. 9, arm bases 28 of arms 26 are disposed within spherical hub arm openings 34 of first half of spherical hub 30 and second half of spherical hub 32, and secured to the prongs of arm hub 40. Once arms 26, first half of spherical hub 30, second half of spherical hub 32 and arm hub 40 are assembled, alternate dryer apparatus 24 comprises an approximate width of 20″.

In operation, alternate dryer apparatus 24 is used in the same manner as dryer apparatus 10 as described above. It shall be appreciated that the half spherical closed ends of arms 26 and the urethane material of arms 26, first half of spherical hub 30, second half of spherical hub 32 and arm hub 40 enhance the durability and heat resistance of the apparatus. This enables alternate dryer apparatus 24 to be suitable for use with high-powered devices such as commercial dryers.

It shall be appreciated that the components of the apparatuses described in several embodiments herein may comprise any alternative known materials in the field and be of any color, size and/or dimensions. For example, alternative materials may be used to fabricate the components including, but not limited to, foam and alternate plastics. It shall be appreciated that the components of the apparatuses described herein may be manufactured and assembled using any known techniques in the field. It shall be appreciated that dryer apparatus 10 and alternate dryer apparatus 24 may reduce the drying time for sheets in a dryer by up to 43 percent. This significantly reduces the energy consumed by dryers, enhances the lifetime of dryers and promotes a healthy environment.

Persons of ordinary skill in the art may appreciate that numerous design configurations may be possible to enjoy the functional benefits of the inventive systems. For example, any alternative number of arms may be used with the apparatuses to achieve a similar benefit. Thus, given the wide variety of configurations and arrangements of embodiments of the present invention the scope of the invention is reflected by the breadth of the claims below rather than narrowed by the embodiments described above.

What is claimed is:

1. An apparatus for use with a dryer to prevent an entanglement of sheets disposed therein and configured to reduce energy consumed by the dryer and a time required to dry the sheets, the apparatus comprising:
a center hub comprising a plurality of tubular prongs oriented such that each tubular prong is equidistant from each adjacent tubular prong; and
a plurality of tubular members comprising first ends affixed to the plurality of tubular prongs, wherein second ends of the plurality of tubular members are configured to sufficiently contact the sheets to create a separation between the sheets to enhance air flow around the sheets when the dryer is operating.

2. The apparatus of claim 1, wherein each tubular prong of the center hub is positioned approximately 90 degrees from each adjacent tubular prong.

3. The apparatus of claim 2, wherein the second end of each tubular member is an opened end and comprises a plurality of notches positioned thereon, wherein the notches are configured to enhance friction between the sheets and the second end of the tubular member.

4. The apparatus of claim 2, wherein the center hub and plurality of tubular members are made from polyvinyl chloride.

5. The apparatus of claim 2, wherein the second end of each tubular member comprises a half spherical closed end.

6. The apparatus of claim 5, wherein the center hub and plurality of tubular members are made from urethane.
